(19) United States
(12) Patent Application Publication
(10) Pub. No.: US 2008/0291809 A1
(43) Pub. Date: Nov. 27, 2008

(54) DISC ROTATION CONTROL METHOD AND VIDEO CAMERA

(76) Inventor: Tatsuya ISHITOBI, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/057,415

(22) Filed: Mar. 28, 2008

(30) Foreign Application Priority Data
May 23, 2007 (JP) 2007-136124

(51) Int. Cl. G11B 23/03

(52) U.S. Cl. 369/267

(57) ABSTRACT

A rotation control method of a disc and a video camera using such a method in the video camera having an optical disc drive therein, wherein a vibration occurring due to the rotation of a disc when data is recorded to the disc during photographing is suppressed, an electric power which is consumed by the disc drive is reduced, a real-time recording is accomplished, and quality of the data which is recorded to the disc is not deteriorated. In the video camera, the disc drive is intermittently driven and a rotational speed of the disc and timing for switching the rotational speed of the disc are controlled.

### INCORPORATION BY REFERENCE

The present application claims priority from Japanese application JP 2007-136124 filed on May 23, 2007, the content of which is hereby incorporated by reference into this application.

### BACKGROUND OF THE INVENTION

The invention relates to a technique regarding rotation control of a disc in a video camera having a disc drive therein.

In a disc drive, a vibration and noises occur when a disc rotates. The vibration and noises become a problem, particularly, in a video camera in which silence is required. In the disc drive, an example of a method of avoiding the problem of the vibration caused by the rotation of the disc has been disclosed in the following Patent Document.

In JP-A-10-92090, the following disclosure exists in “Means for Solving the Problem” of Paragraph [0015]: “In a state where a disc recording medium is rotating at a first rotational speed, when it is identified by a disc identifying unit that the disc recording medium is an eccentric disc or a mass eccentric disc, the set value is changed to a second rotational speed lower than the first rotational speed”.

In JP-A-2001-60357, the following disclosure exists in “Means for Solving the Problem” of Paragraph [0004]: “By controlling so that the disc does not rotate at a predetermined rotational speed at which a vibration peculiar to the disc occurs, the recording or reproducing operation can be executed in a stable state without causing the disc vibration”.

### SUMMARY OF THE INVENTION

It is an object of the invention to provide a rotation control method of a disc in a video camera having an optical disc drive therein, wherein when data is recorded to the disc during photographing, it is suppressed that a vibration which occurs due to a rotation of the disc is propagated to the operator of the video camera, an electric power which is consumed by the disc drive is reduced, and further, while a real-time recording is accomplished, quality of the data which is recorded to the disc is not deteriorated, and to provide the video camera using such a method.

The above object is accomplished by the invention disclosed in Claims. In a video camera, a disc drive is intermittently driven and a rotational speed of the disc and timing for switching the rotational speed of the disc are controlled.

In the video camera having the optical disc drive therein, the video camera which can be easily handled by the user is derived.

Other objects, features and advantages of the invention will become apparent from the following description of the embodiments of the invention taken in conjunction with the accompanying drawings.

### BRIEF DESCRIPTION OF THE DRAWINGS

FIG. 1 is a constructional diagram of a video camera according to the invention;

FIG. 2 is a diagram showing a first disc rotation control method according to the invention;

FIG. 3 is a diagram showing a second disc rotation control method according to the invention; and

FIG. 4 is a diagram showing a third disc rotation control method according to the invention.

### DESCRIPTION OF THE EMBODIMENTS

Since a disc drive for use in a portable apparatus such as a video camera or the like is driven by a battery in which a period of time during which an electric power can be supplied is limited, it is a subject how to reduce electric power consumption. Since the video camera is directly grasped by the hand and used, naturally, it is a subject that a vibration caused in association with a rotation of the disc is suppressed to such a degree that a recording of data to the disc is not obstructed and it is also a subject that the vibration is suppressed to such a degree that it is not propagated to the operator or is permitted to the operator.

As a method decreasing the electric power consumption as a first subject, an intermittent recording in which the data is intermittently recorded to the disc is effective. According to the intermittent recording, the data to be recorded to the disc is temporarily stored into a memory, when an amount of data which is stored into the memory reaches a predetermined amount serving as a reference adapted to start the recording to the disc, the data is recorded to the disc at a speed higher than a transfer rate of the data which is inputted into the memory. When the amount of data stored in the memory decreases to a predetermined amount serving as a reference adapted to stop the recording to the disc, the recording is stopped.

Such an operation that the data to be recorded to the disc is divided into packets, the recording is continuously executed for a period of time during which one packet is recorded, and when the recording of one packet is completed, the recording is halted until the packet to be recorded next is stored into the memory as mentioned above is repeated. Also for a period of time during which the data is recorded to the disc, if the data input into the memory is continuously executed, the reception of the data to be recorded to the disc can be continuously executed although the data is intermittently recorded to the disc. The real-time recording can be realized.

For a period of time during which the intermittent recording is halted, if the disc drive is shifted to a power saving mode in which the rotation of the disc is stopped, a light emission of a laser beam is stopped, a power supply to an electric circuit is stopped, and the like, the electric power which is consumed by the disc drive can be reduced. The higher a speed of the recording to the disc is, the shorter a time necessary for recording one packet is. Consequently, a period of time during which the disc drive is in the power saving mode becomes longer and the electric power consumption can be reduced.

As a method suppressing the vibration which occurs in association with the rotation of the disc as a second subject, a reduction in rotational speed of the disc is effective. The lower the rotational speed of the disc is, the more the vibration occurring due to the rotation of the disc can be reduced. However, if in rotational speed of the disc is decreased, the recording speed of the data to the disc also simultaneously decreases. Therefore, in the foregoing intermittent recording, it takes a time to record one packet, so that a period of time during which the disc drive is held in the power saving mode decreases and the electric power consumption cannot be efficiently suppressed.

In order to accomplish the real-time recording in which the data to be recorded to the disc is continuously received while executing the intermittent recording, the recording speed of the data to the disc needs to be higher than at least an input speed of the data into the memory. Therefore, the rotational speed of the disc cannot be reduced only from a viewpoint of suppressing the vibration.

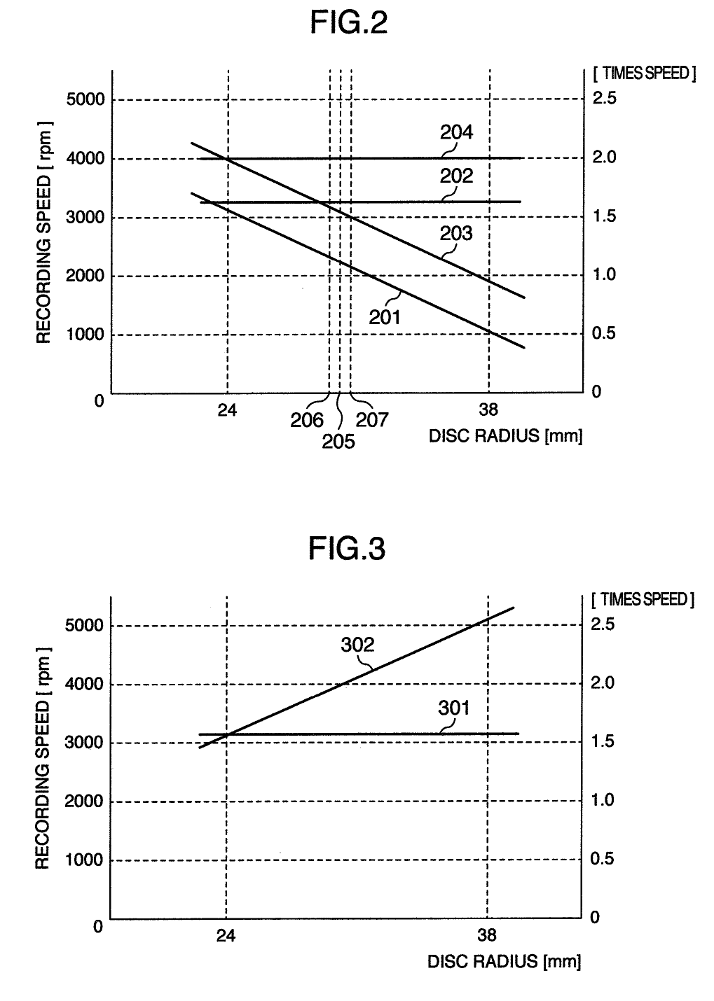

The invention intends to solve the above problem by a first disc rotation control method according to the invention shown in FIG. 2. FIG. 2 is a graph in which an axis of abscissa indicates a radius of the disc, a left axis of ordinate indicates the rotational speed of the disc, and a right axis of ordinate indicates the recording speed of the data to the disc. The control method according to the invention will be described hereinbelow with respect to a disc region in a range from a radius of 24 mm to a radius of 38 mm.

CLV (Constant Linear Velocity) control in which a linear velocity becomes constant is made by rotating the disc at a rotational speed shown at 201 in FIG. 2, so that a recording speed shown at 202 in FIG. 2 is obtained. Likewise, the CLV control is made by rotating the disc at a rotational speed shown at 203 in FIG. 2, so that a recording speed shown at 204 in FIG. 2 is obtained. A case where the control method according to the invention is applied to a recording of a BD (Blu-ray Disc) in which a recordable speed is equal to a 2-times speed will be described. In this case, the rotational speed 201 is set so that the recording speed 202 is set to a 1.6-times speed. The rotational speed 203 is set so that the recording speed 204 is set to a 2-times speed. Under such conditions, the recording is executed at the recording speed 202 until a radius 205 and the recording is executed at the recording speed 204 after the radius 205. By executing the recording at the 1.6-times speed lower than the recordable speed of the disc until the radius 205, the rotational speed of the disc is suppressed to a low speed, so that the vibration occurring due to the rotation of the disc can be suppressed.

After the radius 205, even at the recording speed of the 2-times speed as a recordable speed of the disc, the rotational speed of the disc can be reduced to a low speed in a manner similar to the case of the region before the radius 205, the vibration occurring due to the rotation of the disc does not become a problem. After the radius 205, the recording speed is set to the 2-times speed and the recording time of one packet is shorter than that of the region where the recording is executed at the 1.6-times speed before the radius 205. Therefore, the period of time during which the disc drive can be held in the power saving mode can be further extended and the effective power saving can be realized.

As a method of solving the foregoing problem, the invention also provides a second disc rotation control method shown in FIG. 3. FIG. 3 is a graph in which an axis of abscissa indicates the radius of the disc, a left axis of ordinate indicates the rotational speed of the disc, and a right axis of ordinate indicates the recording speed of the data to the disc. The control method according to the invention will be described hereinbelow with respect to a disc region in a range from a radius of 24 mm to a radius of 38 mm.

CAV (Constant Angular Velocity) control in which an angular velocity becomes constant is made by rotating the disc at a rotational speed shown at 301 in FIG. 3, so that a recording speed shown at 302 in FIG. 3 is obtained. The closer a recording position approaches an outer periphery of the disc, the higher the recording speed of the data to the disc is. Therefore, the closer the recording position approaches an outer periphery of the disc, the more the recording time of one packet is shortened. The period of time during which the disc drive can be held in the power saving mode can be further extended and the electric power which is consumed by the disc drive can be more effectively reduced.

For example, in the BD in which the recordable speed is the 2-times speed, even if the disc rotational speed lies within a range where the vibration does not become a problem, when the recording is executed at a speed over the 2-times speed, it is difficult to assure high recording quality. Therefore, there is a case where such a recording that the recording speed continuously rises from an inner rim of the disc toward an outer rim of the disc as shown in FIG. 3 is impossible.

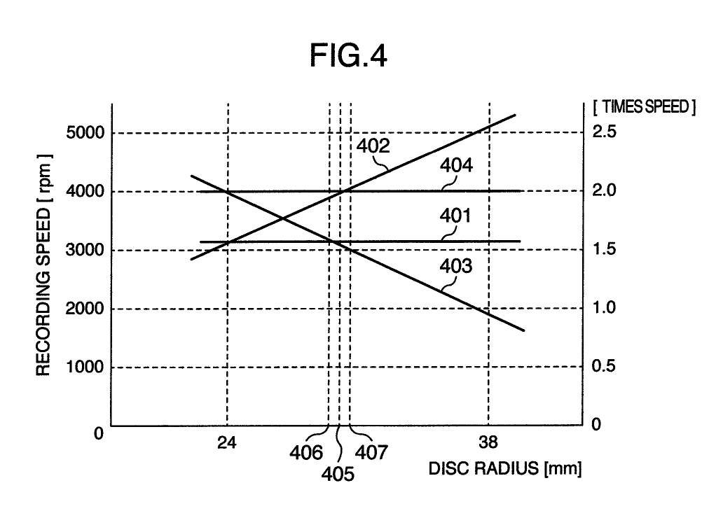

Therefore, the invention provides a disc rotation control method shown in FIG. 4 as a third control method of solving the foregoing problem. FIG. 4 is a graph in which an axis of abscissa indicates the radius of the disc, a left axis of ordinate indicates the rotational speed of the disc, and a right axis of ordinate indicates the recording speed of the data to the disc. The control method according to the invention will be described hereinbelow with respect to a disc region in a range from a radius of 24 mm to a radius of 38 mm.

The CAV (Constant Angular Velocity) control in which an angular velocity becomes constant is made by rotating the disc at a rotational speed shown at 401 in FIG. 4, so that a recording speed shown at 402 in FIG. 4 is obtained. The CLV control in which a linear velocity becomes constant is made by rotating the disc at a rotational speed shown at 403 in FIG. 4, so that a recording speed shown at 404 in FIG. 4 is obtained.

By applying the present method to the recording of the BD in which the recordable speed is the 2-times speed, the rotational speed 401 in FIG. 4 is set to such a value that the recording speed 402 in FIG. 4 starts with the 1.6-times speed and reaches the 2-times speed at a radius shown at 405 in FIG. 4, and the rotational speed 403 in FIG. 4 is set to such a value that the recording speed 404 in FIG. 4 is equal to the 2-times speed. The recording is executed at the recording speed 402 in the disc region until the radius 405. The recording is executed at the recording speed 404 in the disc region after the radius 405.

By this method, the rotational speed of the disc is set into a range of 3200 rpm or less where the vibration occurring due to the rotation of the disc does not become a problem in the whole region, the electric power which is consumed by the disc drive can be effectively reduced.

However, according to the control methods shown in FIGS. 2 and 4, when the rotational speed of the disc is switched, the rotation of the disc is temporarily disturbed and there is a risk of deterioration in recording quality for such a period of time. According to a method whereby the recording is temporarily interrupted and, after the rotation control of the disc is switched, the recording is restarted in order to prevent the disturbance of the rotation from exerting an influence on the recording quality, real-time performance is deteriorated.

Therefore, according to the invention, in the intermittent recording, even if the recording position reached the radius of disc where the rotation control of the disc is switched during the recording, the rotation control of the disc is not switched until the recording of one packet in the intermittent recording has been completed, but the rotation control is switched just before the start of the recording of the next packet. Or, before the start of the recording of the packet, if it is predicted that the recording position reaches the radius where the rotation control of the disc is switched during the recording of the packet, after completion of the switching of the rotation control of the disc, the recording of the packet is started. Such a control method will be described with reference to FIGS. 2 and 4.

An explanation will be made with respect to the case where one packet is recorded in the intermittent recording in a range from a disc radius 206 shown in FIG. 2 to a position just before a disc radius 207 shown in FIG. 2. When the recording is started at the recording speed 202 from the radius 206, the recording position reaches the radius 205 as a switching position of the rotation control during the recording. Although the recording speed is inherently switched to 204 from this radius, since the recording of one packet is not completed yet, the recording is continued as it is at the recording speed 202 to the position just before the radius 207 in accordance with the control method of the invention. After that, when the packet is recorded in the disc region after the radius 207, the recording is executed at the recording speed 204.

In the case of recording one packet in a range from a disc radius 406 shown in FIG. 4 to a position just before a disc radius 407 shown in FIG. 4, when the recording is started at the recording speed 402 from the radius 406, it will be understood from a data size of the packet that the recording position reaches the radius 405 as a switching position of the rotation control during the recording. In such a case, although the recording position is in the region where the recording speed 402 is ordinarily applied, the recording speed is preliminarily switched to the recording speed 404 and, thereafter, the packet is recorded from the radius 406.

If the rotation control of the disc is switched as mentioned above while avoiding the recording state as described with reference to FIGS. 2 and 4, the disturbance of the rotation of the disc that is caused by the switching of the rotation control does not exert an influence on the recording quality. Since the rotation control of the disc does not obstruct the recording process, the above control method is also suitable for the real-time recording.

Naturally, in order to realize the real-time recording in which the data to be recorded to the disc is continuously received while intermittently recording the data to the disc in the above example, the recording speed of the data to the disc needs to be higher than at least the input speed of the data into the memory. Therefore, it is presumed as a prerequisite that the input speed of the data into the memory does not exceed the recording speed of the data to the disc.

An example for embodying the invention will be described hereinbelow.

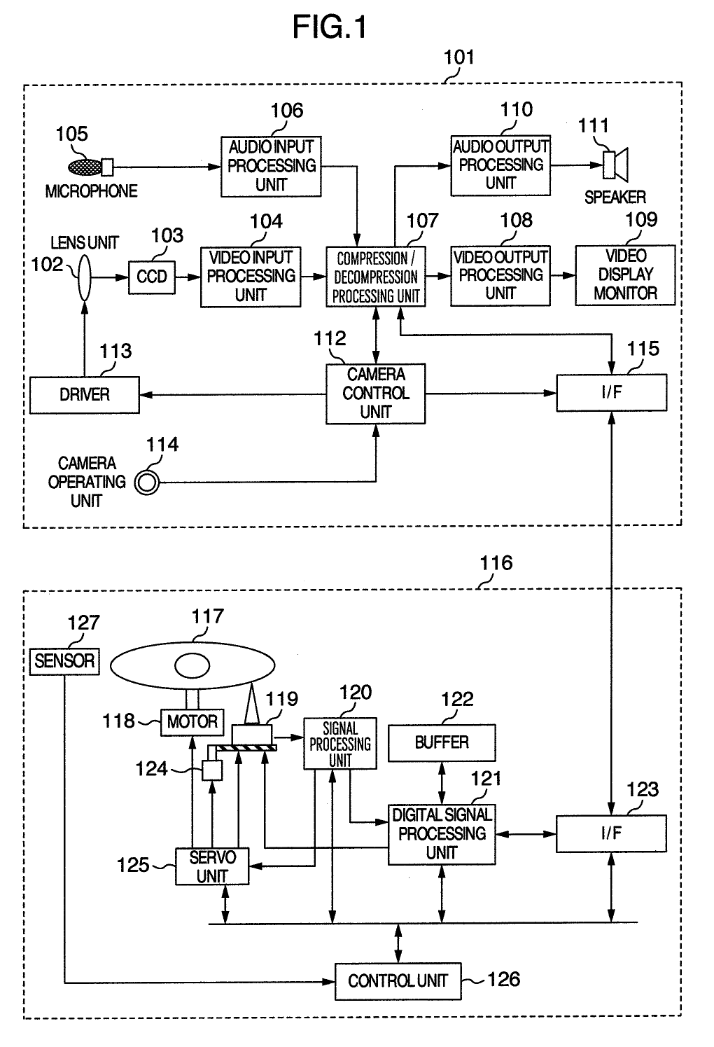

FIG. 1 shows a construction of a video camera having the optical disc drive therein. A portion 101 surrounded by a broken line in FIG. 1 corresponds to an image pickup apparatus. A portion 116 surrounded by a broken line in FIG. 1 corresponds to a disc drive.

The image pickup apparatus 101 shown in FIG. 1 is constructed by: a lens unit 102; an image pickup sensor 103; a video input processing unit 104; a microphone 105; an audio input processing unit 106; a compression/decompression processing unit 107; a video output processing unit 108; a video display monitor 109; an audio output processing unit 110; a speaker 111; a camera control unit 112; a lens unit driver 113; a camera operating unit 114; and a disc drive interface 115.

The disc drive 116 shown in FIG. 1 is constructed by: a disc 117 (which is removable from the disc drive 116); a spindle motor 118; an optical pickup 119; an analog signal processing unit 120; a digital signal processing unit 121; a buffer memory 122; a camera interface 123; a course motor 124; a servo unit 125; a disc drive control unit 126; and a disc lid opening/closure sensor 127 (a disc lid is not illustrated).

When the disc is inserted into the video camera and the lid to cover the disc is closed, in the disc drive, the disc drive control unit 126 detects the insertion of the disc through the disc lid opening/closure sensor 127 and executes a recognizing process of the disc. To recognize the disc, the disc drive control unit 126 issues a command to the servo unit 125, thereby executing a light emission of a laser beam by a rotation of the spindle motor 118 and a reproducing power from the optical pickup 119. When the laser beam is irradiated to the disc, its reflection light is converted into an electric signal by the optical pickup 119. Further, the electric signal is sent to the analog signal processing unit 120, by which error signals necessary for focusing servo control, tracking servo control, and the like are formed.

When the error signals formed in the analog signal processing unit 120 are transmitted to the servo unit 125, the focusing servo control, tracking servo control, and the like can be made in the servo unit 125. The disc drive 116 enters a state where the data can be read out of the disc, so that the disc can be recognized.

In the disc drive 116, after completion of the recognizing process of the disc, the disc drive control unit 126 notifies the image pickup apparatus 101 of the completion of an activating process through the camera interface 123. In response to a notification showing the completion of the activation from the disc drive 116, the image pickup apparatus 101 reads out the data from the optical disc 117. If it is determined that the disc 117 is a disc which can be used, the image pickup apparatus 101 enters a mode in which the photographing operation can be performed. The image pickup apparatus 101 requires the disc drive 116 to shift to the power saving mode until a photographing request is issued from the user.

When the request to shift to the power saving mode is received from the image pickup apparatus 101, the disc drive 116 stops the laser light emission from the optical pickup 119, stops the spindle motor 118, stops the power supply and clock supply to each of the foregoing processing units, and shifts to the power saving mode under the control of the disc drive control unit 126.

After that, when the photographing is started by the operation of the camera operating unit 114 by the user, the camera control unit 112 knows that the start of the photographing has been requested through the camera operating unit 114, and starts to fetch a video image through the lens unit 102 which is driven by the lens unit driver 113. The fetched video image is converted into an electric signal in the image pickup sensor 103 and converted into a video signal in the video input processing unit 104. At the same time, au audio sound is fetched by the microphone 105. The fetched audio sound is converted into an audio signal in the audio input processing unit 106.

The video signal formed in the video input processing unit 104 and the audio signal formed in the audio input processing unit 106 are compressed by the compression/decompression processing unit 107 and, thereafter, temporarily stored. The camera control unit 112 monitors an amount of data stored in the compression/decompression processing unit 107. When the data amount reaches a predetermined amount in which the data transfer to the disc drive should be started, the camera control unit 112 sends a recording request command and an address as position information indicative of the data recording position to the disc drive 116 through the disc drive interface 115.

The disc drive 116 which has received them is returned from the power saving mode under the control of the disc drive control unit 126 and is shifted to an operating mode where the data can be recorded to the disc. Subsequently, the disc drive 116 receives the data stored in the compression/decompression processing unit 107 of the image pickup apparatus 101 through the camera interface 123 and temporarily stores into the buffer memory 122.

While the data is temporarily stored into the buffer memory, the disc drive control unit 126 decides a movement destination of the optical pickup 119 and a rotational speed and a rotation control method of the spindle motor 118 on the basis of the position information instructed from the image pickup apparatus 101 and issues an instruction to the servo unit 125.

When the instruction is received from the disc drive control unit 126, the servo unit 125 moves the optical pickup 119 to a position in front of the recording designated position by driving the course motor 124 and rotates the spindle motor 118 at a designated rotational speed by a designated rotation control method.

At the same time, the disc drive control unit 126 instructs the digital signal processing unit 121 to record the data into an address on the disc designated by the image pickup apparatus 101. The digital signal processing unit 121 which has received the instruction adds an error correction code to the data stored in the buffer memory 122 and further executes a modulating process to the data. When the address instructed from the disc drive control unit 126 is detected through an address signal which is obtained through the optical pickup 119 and the analog signal processing unit 120, the modulation processed data is sent to the optical pickup 119.

Thus, the laser beam of a light emission pattern based on the modulated data is irradiated from the optical pickup 119 onto the disc 117 at the recording level, so that the data is recorded onto the disc.

When the recording data of an amount corresponding to one recording operation in the intermittent recording is sent to the disc drive 116 from the compression/decompression processing unit 107, the image pickup apparatus 101 stops the data transfer to the disc drive 116 and requests the disc drive 116 to again shift to the power saving mode. After all of the data sent from the image pickup apparatus 101 was recorded to the disc, the disc drive 116 is shifted again to the power saving mode in accordance with a request of the image pickup apparatus 101.

By repeating the above operation, in the disc drive 116, the intermittent data recording to the disc is performed. Since the disc drive is shifted to the power saving mode for a period of time during which the data is not recorded to the disc, the electric power consumption in the disc drive 116 can be suppressed.

As for the rotational speed of the disc during the recording, since the disc rotation control method according to the invention is applied, the vibration occurring due to the rotation of the disc does not become a problem during the whole recording and the rotation control method is not switched during the recording. Therefore, the rotation of the disc is not disturbed and the recording quality is not deteriorated.

Further, although it is presumed as a prerequisite that a data bit rate upon recording to the disc in the disc drive 116 is higher than a data bit rate of video information which is fetched by the image pickup apparatus 101, also for a period of time during which the data is transmitted to the disc drive 116, by subsequently executing the series of processes such as fetching of the video image, conversion of the signal, compression of the signal, and accumulation of the data in the image pickup apparatus 101, the real-time recording is realized even if the intermittent data recording to the disc is executed.

Since such a situation that the recording is interrupted during the recording of the data to the disc does not occur in order to switch the rotation control of the disc, the real-time performance is not deteriorated.

According to the embodiment of the invention, in the video camera having the optical disc drive therein, the vibration occurring due to the rotation of the disc when the data is recorded to the disc during the photographing is suppressed and the electric power which is consumed by the disc drive is reduced. The video camera in which the real-time recording is accomplished and the quality of the data which is recorded to the disc is not deteriorated is obtained.

It should be further understood by those skilled in the art that although the foregoing description has been made on embodiments of the invention, the invention is not limited thereto and various changes and modifications may be made without departing from the spirit of the invention and the scope of the appended claims.

1. A video camera comprising
a disc drive and
a memory for temporarily storing data obtained by photographing,
wherein an intermittent recording in which the following operation is repeated is executed during the photographing:
said disc drive is set into a power saving mode for a period of time until a data mount in said memory reaches a predetermined amount;
when the data mount in said memory reaches the predetermined amount, the data of the predetermined amount in said memory is recorded to a disc of said disc drive; and
when said disc drive has recorded the data of the predetermined amount, said disc drive is set into the power saving mode for the period of time until the data mount in said memory reaches the predetermined amount again;
and when the data is recorded to the disc, a switching of a rotational speed of the disc and a rotation control method is performed in accordance with a disc region where the data is recorded.

2. A video camera according to claim 1, wherein the switching of the rotational speed of the disc and the rotation control method is performed by using a period of time during which the data recording to the disc is not executed in said intermittent recording.

3. A video camera according to claim 1, wherein when the data is recorded to the disc, by switching a speed of recording the data to the disc in accordance with the disc region where the data is recorded, a period of time during which said disc drive is set into the power saving mode is adjusted.

4. A rotation control method of a disc in a disc drive which is built in a video camera and is intermittently driven by said video camera, comprising the steps of:
when data is recorded to the disc, switching a rotational speed of the disc and a rotation control method in accordance with a disc region where the data is recorded.

5. A method according to claim 4, wherein the rotational speed of the disc and the rotation control method are switched by using a period of time during which the data recording to the disc is not executed in said intermittent recording.

6. A method according to claim 4, wherein when the data is recorded to the disc, by switching a speed of recording the data to the disc in accordance with the disc region where the data is recorded, a time which is required for said disc drive to record the data is adjusted.
